(19) United States
(12) Patent Application Publication
(10) Pub. No.: US 2019/0007868 A1
(43) Pub. Date: Jan. 3, 2019

(54) MANAGEMENT SYSTEM, MOBILE OBJECT, MANAGEMENT DEVICE, LOCATION NOTIFICATION METHOD, MANAGEMENT METHOD, AND PROGRAM

(71) Applicant: NEC Corporation, Minato-ku, Tokyo (JP)

(72) Inventors: Makoto FUJINAMI, Tokyo (JP); Yasuhiro MIZUKOSHI, Tokyo (JP)

(73) Assignee: NEC Corporation, Minato-ku, Tokyo (JP)

(21) Appl. No.: 16/066,096

(22) PCT Filed: Dec. 22, 2016
(86) PCT No.: PCT/JP2016/088469

§ 371 Date: Jun. 26, 2018

(30) Foreign Application Priority Data
Dec. 28, 2015 (JP) 2015-255557

(51) Int. Cl. H04W 28/10; H04W 4/029

(52) U.S. Cl. CPC H04W 28/10; H04W 4/029

(57) ABSTRACT

Provided is a management system for solving the problem of an increase in the load on a network when managing the location of a mobile object in the cloud. The management system includes: a mobile object for estimating the location of a host device after a predetermined time has elapsed, using a predetermined motion model; and a management device for estimating the location of the mobile object after the predetermined time has elapsed, using the predetermined motion model. The mobile object transmits information relating to the location of the host device to the management device in response to the fact that the error between the location of the host device measured after the predetermined time has elapsed and the estimated location of the host device has exceeded a predetermined threshold value.

### TECHNICAL FIELD

The present invention relates to a management system, a mobile object, a management device, a location notification method, a management method, and a program.

### BACKGROUND ART

PTL 1 discloses a system for managing a location of a mobile terminal in a cloud. The system described in PTL 1 identifies a location of a mobile terminal, and successively transmits information on the identified location to a mobile management server on the cloud side via a network. The mobile management server on the cloud side provides a service based on a location of a mobile terminal, on the basis of location information successively transmitted from the mobile terminal.

### CITATION LIST

### Patent Literature

[PTL 1] International Publication No. WO2013/161439

### SUMMARY OF INVENTION

### Technical Problem

In the system described in PTL 1, a mobile terminal successively transmits identified location information to a mobile management server on the cloud side via a network. Therefore, in the system described in PTL 1, communication traffic between a mobile terminal and a mobile management server becomes enormous, and load of a network increases. When Internet of Things (IoT) and machine to machine (M2M) spread, it is expected that the number of mobile terminals increases, and an increase in load of a network becomes conspicuous.

In view of the above-described problem, an object of the present invention is to provide a mobile object, a management device, a management system, and a program, which enable to suppress an increase in load of a network when a location of the mobile object is managed on a cloud side.

### Solution to Problem

A management system according to one aspect of the present invention includes: a mobile object for estimating a location of an own device after a predetermined time elapses by using a predetermined motion model; and a management device for estimating a location of the mobile object after the predetermined time elapses by using the predetermined motion model, wherein the mobile object transmits, to the management device, location-relation information of the own device when an error, between a location of the own device measured after a predetermined time elapses and the estimated location of the own device, exceeding a predetermined threshold value.

A mobile object according to one aspect of the present invention includes: first means for transmitting location-relation information of an own device to a management device; and second means for estimating a location of an own device after a predetermined time elapses, wherein the second means transmits the location-relation information of the own device via the first means when an error, between the location of the own device measured after the predetermined time elapses and the estimated location of the own device, exceeding a predetermined threshold value.

A management device according to one aspect of the present invention, the management device being for managing a location of a mobile object, includes: first means for receiving location-relation information of the mobile object from the mobile object; and second means for estimating a location of the mobile object after a predetermined time elapses, wherein the second means manages the estimated location as the location of the mobile object during a period until newly receiving the location-relation information of the mobile object after receiving the location-relation information of the mobile object.

A location notification method according to one aspect of the present invention includes: transmitting, to a management device, location-relation information of an own device being a mobile object; estimating a location of an own device after a predetermined time elapses; and transmitting, to the management device, the location-relation information of the own device when an error, between the location of the own device measured after the predetermined time elapses and the estimated location of the own device, exceeding a predetermined threshold value.

A management method according to one aspect of the present invention includes: receiving location-relation information of a mobile object from the mobile object; estimating a location of the mobile object after a predetermined time elapses; and managing the estimated location as the location of the mobile object during a period until newly receiving the location-relation information of the mobile object after receiving the location-relation information of the mobile object.

A program according to one aspect of the present invention causing a computer to execute: transmitting location-relation information of an own device to a management device; estimating a location of an own device after a predetermined time elapses; and transmitting, to the management device, the location-relation information of the own device when the error, between the location of the own device measured after the predetermined time elapses and the estimated location of the own device, exceeding a predetermined threshold value.

A program according to one aspect of the present invention causing a computer to execute: receiving location-relation information of a mobile object from the mobile object; estimating a location of the mobile object after a predetermined time elapses; and managing the estimated location as the location of the mobile object during a period until newly receiving location-relation information of the mobile object after receiving information of the mobile object.

### Advantageous Effects of Invention

A management system, a mobile object, a management device, a management method, and a program according to the present invention enable to suppress an increase in load of a network when a location of the mobile object is managed on a cloud side.

### BRIEF DESCRIPTION OF DRAWINGS

FIG. 1 is a configuration example of a management system according to a first example embodiment.

FIG. 2 is a configuration example of a mobile object 1 according to the first example embodiment.

FIG. 3 is an example of a motion estimation circle of the mobile object 1 according to the first example embodiment.

FIG. 4 is another example of the motion estimation circle of the mobile object 1 according to the first example embodiment.

FIG. 5 is another example of the motion estimation circle of the mobile object 1 according to the first example embodiment.

FIG. 6 is another example of the motion estimation circle of the mobile object 1 according to the first example embodiment.

FIG. 7 is a configuration example of a management device 2 according to the first example embodiment.

FIG. 8 is a flowchart illustrating an operation example of the mobile object 1 according to the first example embodiment.

FIG. 9 is a flowchart illustrating another operation example of the mobile object 1 according to the first example embodiment.

FIG. 10 is a flowchart illustrating an operation example of the management device 2 according to the first example embodiment.

FIG. 11 is a flowchart illustrating another operation example of the management device 2 according to the first example embodiment.

FIG. 12 is a configuration example of a management system according to a second example embodiment.

FIG. 13 is a configuration example of a mobile object 1 according to the second example embodiment.

FIG. 14 is an example of a motion estimation circle of the mobile object 1 according to the second example embodiment.

FIG. 15 is another example of the motion estimation circle of the mobile object 1 according to the second example embodiment.

FIG. 16 is a display example of a display unit of the mobile object 1 according to the second example embodiment.

FIG. 17 is a flowchart illustrating an operation example of the mobile object 1 according to the second example embodiment.

FIG. 18 is a flowchart illustrating an operation example of the management device 2 according to the second example embodiment.

### EXAMPLE EMBODIMENT

In the following, example embodiments and examples according to the present invention will be described with reference to the drawings. The respective example embodiments are examples. The present invention is not limited to the respective example embodiments. Note that reference numbers in the drawings appended to this summary are provided to respective elements for convenience, as an easy-to-understand example. Description of this summary does not intend any limitation.

### First Example Embodiment

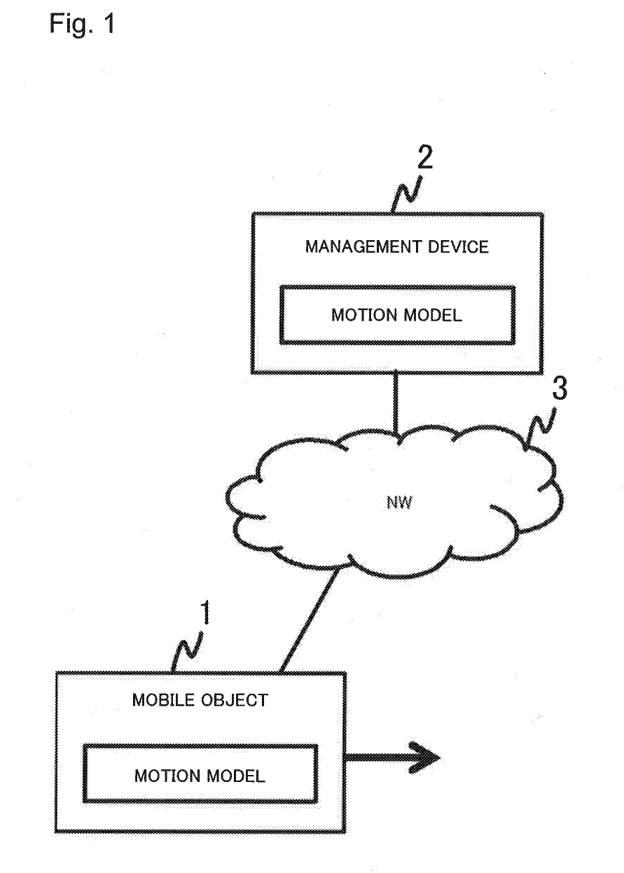

FIG. 1 is a diagram illustrating a configuration example of a management system according to a first example embodiment of the present invention.

In the first example embodiment, a mobile object 1 holds a motion model associated with a management device 2, the management device 2 holds a motion model associated with the mobile object 1, and both estimate a location of the mobile object 1 after a predetermined time has elapsed. The both associated motion models may be the same motion models, for example. Since each of the mobile object 1 and the management device 2 estimates a location of the mobile object 1 by using its motion model associated with each other, estimated locations of the mobile object 1 to be estimated by the mobile object 1 and the management device 2 exhibit substantially same results.

Therefore, when an error, between a location and an estimated location of the mobile object 1 after a predetermined time has elapsed, is small, the management device 2 manages the estimated location as the location of the mobile object 1. Since an error between an actual location and an estimated location is small, the management device 2 is able to manage the estimated location as the location of the mobile object 1. Further, since the management device 2 manages an estimated location as a location of the mobile object 1, the management device 2 does not have to receive a notification on location information on the mobile object 1 from the mobile object 1. Therefore, the mobile object 1 does not have to notify the management device 2 of location information on the mobile object 1. This enables to suppress an increase in communication traffic.

Specifically, when an error, between an actual location of the mobile object 1 and an estimated location estimated by using a motion model, exceeds a predetermined threshold value, the mobile object 1 notifies the management device 2 of location-relation information of the mobile object 1. On the other hand, when an error, between an actual location of the mobile object 1 and an estimated location estimated by using a motion model, does not exceeds a predetermined threshold value, the mobile object 1 does not notify the management device 2.

After receiving location-relation information of the mobile object 1 from the mobile object 1, the management device 2 manages an estimated location estimated by using a motion model as a location of the mobile object 1 during a period until newly receiving location-relation information of the mobile object 1.

Therefore, the management system according to the first example embodiment does not have to transmit and receive location-relation information of the mobile object 1 between the mobile object 1 and the management device 2, when an error, between an actual location of the mobile object 1 and an estimated location of the mobile object 1 estimated by using a motion model, does not exceeds a predetermined threshold value. Thus, the management system according to the first example embodiment is able to suppress an increase in communication traffic.

As illustrated in FIG. 1, the management system according to the first example embodiment includes the mobile object 1, the management device 2, and a network (NW) 3.

The NW 3 is Long Term Evolution (LTE), for example. The NW 3, however, is not limited to LTE, but may be any network such as General Packet Radio Service (GPRS), Universal Mobile Telecommunication System (UMTS), and Worldwide Interoperability for Microwave Access (WiMAX).

The mobile object 1 is a device (object) whose location changes, such as an automobile, a bicycle, a drone, an airplane, and a vessel, for example. Further, the mobile object 1 may be a device carried by a user such as a mobile phone, a Personal Computer (PC), a mobile router, and a smart device (e.g. a wearable terminal), and may be a device that moves with the user, for example. Note that the mobile object 1 is not limited to these examples, but may be a Machine to Machine (M2M) device, and the like. Note that the mobile object 1 may be a communication device (e.g. a mobile phone, a smartphone, a car navigation system, and the like) included in an object that moves such as an automobile, a train, and an airplane. Note that the mobile object 1 is a movable object, and is not limited to an object that is constantly moving. For example, the mobile object 1 is able to stay (location information on the mobile object 1 remains unchanged during a predetermined period).

The mobile object 1 transmits location-relation information of an own device to the management device 2. The mobile object 1 transmits location-relation information of an own device to the management device 2 at a predetermined timing, for example. The mobile object 1 transmits, to the management device 2, location information on an own device measured by a global positioning system (GPS) (e.g. a latitude and a longitude of the mobile object 1), for example. The mobile object 1 may transmit location-related information of an own device (e.g. an acceleration and a velocity of the mobile object 1). Further, the mobile object 1 may transmit, to the management device 2, a motion model for use in calculating a location of an own device.

The management device 2 manages location-relation information of the mobile object 1. The management device 2 manages a location of the mobile object 1, based on location-relation information of the mobile object 1 received from the mobile object 1 (location information and/or location-related information). The management device 2 manages location information received from the mobile object 1 (e.g. a latitude and a longitude of the mobile object 1), for example. The management device 2 may calculate a location of the mobile object 1, based on received location-related information (e.g. a velocity and an acceleration of the mobile object 1), and manage the calculated location of the mobile object 1, for example. Note that, when receiving a motion model for use in calculating a location of the mobile object 1, the management device 2 may calculate a location of the mobile object 1 by using the received motion model, and manage the calculated location of the mobile object 1.

The management device 2 estimates a location of the mobile object 1 after a predetermined time has elapsed, based on a predetermined motion model. The management device 2 estimates a location of the mobile object 1 after a predetermined time has elapsed by using a predetermined motion model, based on the received location-relation information of the mobile object 1, for example. Note that the management device 2 may calculate a location of the mobile object 1, based on location-relation information received from the mobile object 1, and thereafter, estimate a location of the mobile object 1 after a predetermined time has elapsed by using a predetermined motion model, based on the calculated location of the mobile object 1. When receiving a motion model from the mobile object 1, the management device 2 may estimate a location of the mobile object 1 after a predetermined time has elapsed by using the motion model.

The management device 2 manages an estimated location of the mobile object 1 after a predetermined time has elapsed. After receiving location-relation information from the mobile object 1, the management device 2 manages an estimated location of the mobile object 1 as a location of the mobile object 1 during a period until newly receiving location-relation information from the mobile object 1.

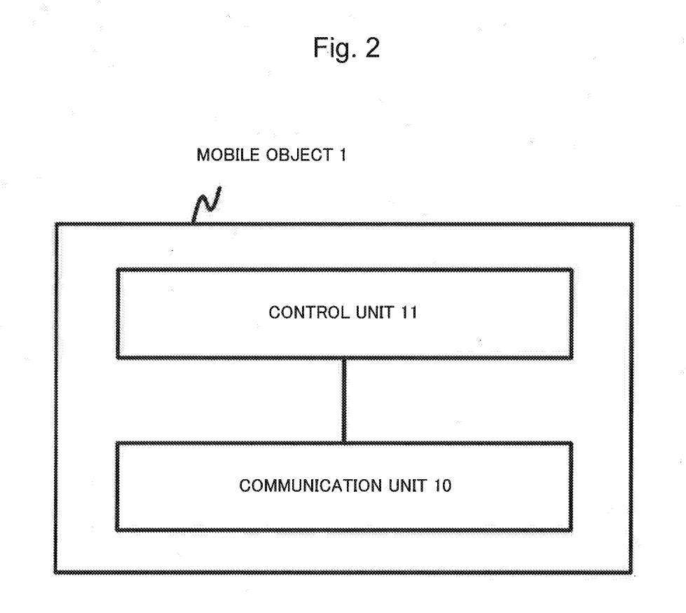

FIG. 2 is a diagram illustrating a configuration example of the mobile object 1 according to the first example embodiment. As exemplified in FIG. 2, the mobile object 1 includes a communication unit 10 and a control unit 11.

The communication unit 10 has a function of transmitting and receiving a predetermined signal, data, and the like. The communication unit 10 is an interface for communication, for example.

The control unit 11 measures location-relation information of an own device. The control unit 11 measures location-relation information of an own device at a predetermined period, for example. The control unit 11 measures location-relation information of an own device at a predetermined timing, for example. Location-relation information of the mobile object 1 is location information on the mobile object 1 and/or location-related information of the mobile object 1, for example. Note that location-relation information of the mobile object 1 is not limited to location information, but may include a motion model for use in calculating a location of the mobile object 1, for example.

The control unit 11 measures location information on an own device (e.g. a latitude and a longitude) by a GPS, for example. Location information may include an altitude of an own device, an elevation where the mobile object 1 is located, and the like, in addition to a latitude and a longitude. Note that location information is not limited to these examples, but may be any information when the information indicates a location of the mobile object 1. Note that location information is settable depending on an attribute of the mobile object 1. For example, when the mobile object 1 is an automobile, location information includes a latitude and a longitude. Further, when the mobile object 1 is a drone or an airplane, location information includes a latitude, a longitude, and an altitude.

Further, the control unit 11 measures location-related information of an own device (e.g. a velocity and an acceleration of the own device), for example. Location-related information may be angular moment with respect to respective axes (X-axis, Y-axis, Z-axis), a “speed” being a scalar quantity, and the like, in addition to a velocity and an acceleration.

Location-related information may be a parameter included in a motion model for use in calculating a location of the mobile object 1. Location-related information may be a motion model for use in calculating a location of the mobile object 1. A motion model includes an equation of motion for calculating a location of the mobile object 1, for example.

Location-related information may be information indicating a location of the mobile object 1 on a predetermined map, for example. Location-related information may be information for calculating a location of the mobile object 1 on a predetermined map, such as a vector quantity of the mobile object 1 in a traveling direction on a predetermined map, for example.

Note that location-related information is not limited to these examples. When location-related information is information for calculating a location of the mobile object 1, any information may be employed. Note that a location of the mobile object 1 may be a location relative to another mobile object 1, for example.

The control unit 11 estimates a location of the mobile object 1 after a predetermined time has elapsed, based on a predetermined motion model. Note that a “predetermined motion model” included in the mobile object 1 is a model associated with a “predetermined motion model” included in the management device 2. A “predetermined motion model” included in the mobile object 1, and a “predetermined motion model” included in the management device 2 may be the same.

An estimated location of the mobile object 1 to be estimated by the control unit 11 may be a “predetermined area” having a possibility that the mobile object 1 may move after a predetermined time has elapsed, for example. The control unit 11 estimates a location of the mobile object 1 after a predetermined time has elapsed as a motion estimation circle by using a Kalman filter, for example. Note that it is needless to say that the control unit 11 may calculate an estimated location of the mobile object 1 by a method other than a Kalman filter. Further, the control unit 11 may estimate an estimated location of the mobile object 1 not as a motion estimation area but as a “point”.

Further, when estimating a motion estimation area regarding an estimated location of the mobile object 1, the control unit 11 may estimate a “point” at which the mobile object 1 may move with a highest possibility in the motion estimation area.

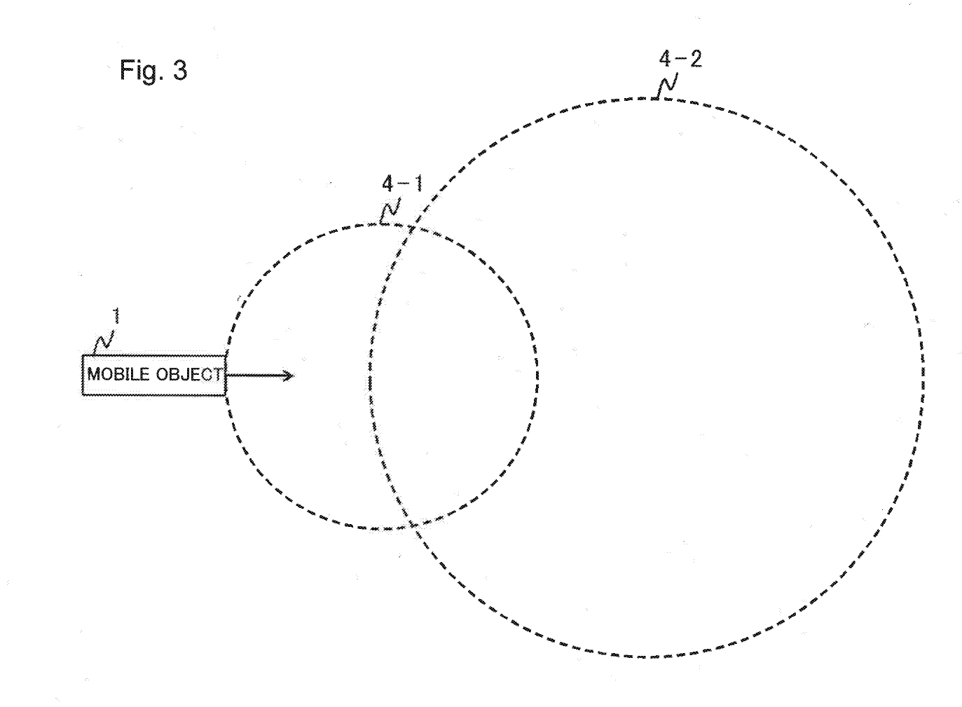

FIG. 3 is a diagram exemplifying a motion estimation circle to be estimated by the control unit 11. The control unit 11 calculates a motion estimation circle 4-1, as an estimated location of the mobile object 1 after a predetermined time “t” has elapsed by using a Kalman filter, for example. The control unit 11 calculates a motion estimation circle 4-2, as an estimated location of the mobile object 1 after a predetermined time “2t” has elapsed by using a Kalman filter. Note that the example of FIG. 3 illustrates a motion estimation circle 4 until a time when a predetermined time “2t” has elapsed. It is needless to say, however, that the control unit 11 may calculate a motion estimation circle 4 after a time when a predetermined time “2t” has elapsed.

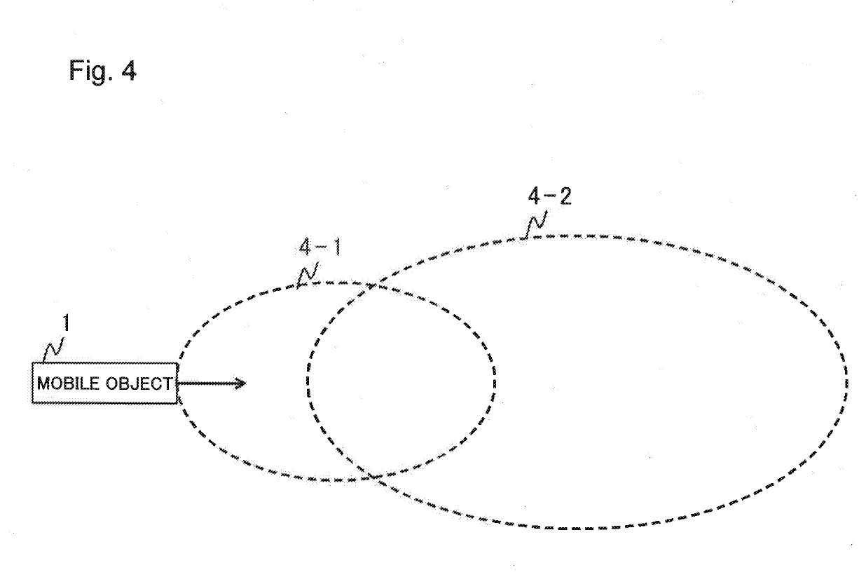

FIG. 4 is a diagram exemplifying a motion estimation area to be estimated by the control unit 11. The control unit 11 may estimate an estimated location of the mobile object 1 as a motion estimation circle as illustrated in FIG. 3. Alternatively, as illustrated in FIG. 4, the control unit 11 may estimate an estimated location of the mobile object 1 as an estimation area of an elliptical shape, for example. In the example of FIG. 4, the control unit 11 estimates a motion estimation area of the mobile object 1 wider (longer) in a traveling direction than a direction orthogonal to the traveling direction. Therefore, in the example of FIG. 4, by calculating a motion estimation area of the mobile object 1 wide (long) in a traveling direction, the motion estimation area of the mobile object 1 has an elliptical shape.

A size of a motion estimation area of the mobile object 1 to be estimated by the control unit 11 may be set depending on an attribute and a type of the mobile object 1. The control unit 11 sets a motion estimation area large with respect to a mobile object 1 that moves at a fast speed such as an automobile, for example. On the other hand, the control unit 11 sets a motion estimation area small with respect to a mobile object 1 that moves at a slow speed such as a smartphone carried by a pedestrian, for example.

Further, a size of a motion estimation area of the mobile object 1 to be estimated by the control unit 11 may be set depending on a condition of a place where the mobile object 1 is located. When the mobile object 1 being an automobile is located on a highway, for example, the control unit 11 sets a motion estimation area large. On the other hand, when the mobile object 1 being an automobile is located near an intersection, for example, the control unit 11 sets a motion estimation area small.

Note that an area on an estimated location of the mobile object 1 to be estimated by the control unit 11 is not limited to the examples of FIG. 3 and FIG. 4, but may be any area. Further, in FIG. 3 and FIG. 4, the control unit 11 estimates a motion estimation area of the mobile object 1, as a two-dimensional area. The control unit 11 may estimate a motion estimation area of the mobile object 1 as a one-dimensional area or a three-dimensional area, for example. Further, in FIG. 3 and FIG. 4, the control unit 11 sets a size of a motion estimation area after a predetermined time “2t” has elapsed large between a motion estimation area after a predetermined time “t” has elapsed, and the motion estimation area after the predetermined time “2t” has elapsed. Alternatively, a size of a motion estimation area may be any size. For example, the control unit 11 may estimate a motion estimation area after a predetermined time “t” has elapsed and a motion estimation area after a predetermined time “2t” has elapsed as motion estimation areas of substantially the same sizes. It is needless to say that a size of a motion estimation area after a predetermined time “2t” has elapsed may be smaller than a size of a motion estimation area after a predetermined time “t” has elapsed.

Further, an area of an estimated location of the mobile object 1 to be estimated by the control unit 11 may be set, based on a date and time, a point of time, a time zone, weather information such as weather, and a car type in which the mobile object 1 is an automobile. For example, an area of an estimated location of the mobile object 1 is set to be narrow with respect to a date and time, a point of time, a time zone, a copy, and a car type in which a frequency of occurrence of an accident is statistically higher than a reference value, as compared with a date and time, etc., when the frequency is lower than the reference value, for example.

Further, in the examples of FIG. 3 and FIG. 4, the control unit 11 estimates a motion estimation area of the mobile object 1 each time after a predetermined time “t” has elapsed. Alternatively, the control unit 11 may not estimate a motion estimation area each time after a predetermined time “t” has elapsed, but may estimate a motion estimation area on a real-time basis.

Further, the predetermined time “t” is set, based on an attribute of the mobile object 1, for example. When the mobile object 1 is, for example, an automobile, a train, a drone, and the like, the predetermined time “t” is set to 10 [ms], for example. When the mobile object 1 is, for example, a smartphone, a mobile phone, and the like carried by a user, the predetermined time “t” is set to 1 [s], for example. Note that the predetermined time “t” is not limited to these examples, but may be any time width such as 1 [ms].

Note that the predetermined time “t” may be a time that is determined in advance, or may be changeable depending on a condition of the mobile object 1. For example, when the mobile object 1 is an automobile, for example, the predetermined time “t” may be set shorter in a case where an automobile being the mobile object 1 is located at an intersection than in a case where the automobile is located on a highway. It is needless to say that the predetermined time “t” may be set shorter in a case where an automobile being the mobile object 1 is located on a highway than in a case where the automobile is located at an intersection.

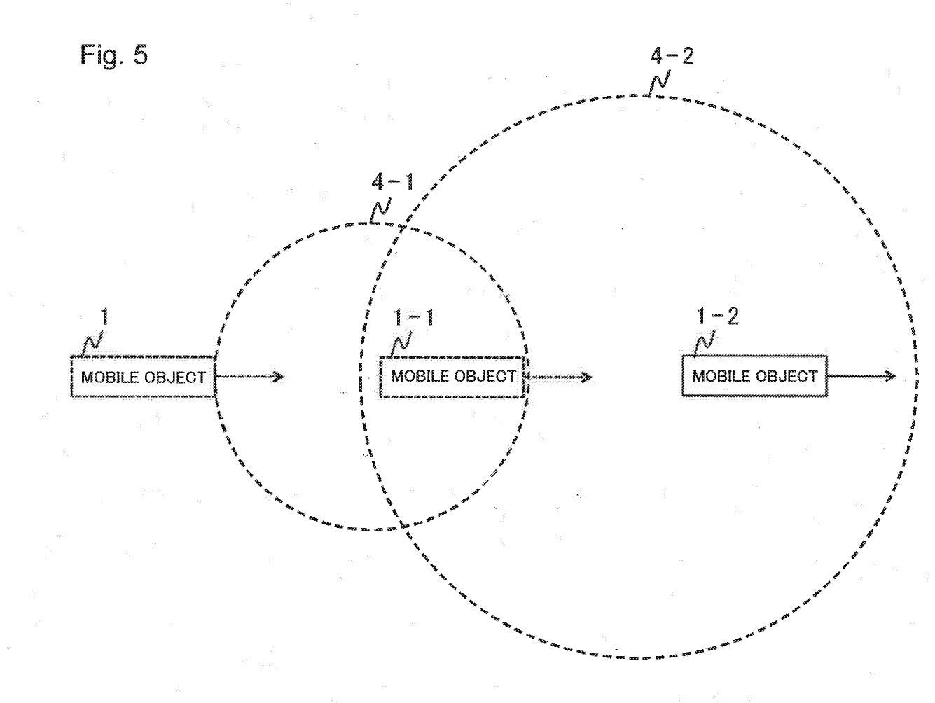

FIG. 5 is a diagram illustrating a relationship between an actual location of the mobile object 1 and a motion estimation circle after the predetermined time “2t” has elapsed.

Further, the predetermined time “t” may be set, based on a date and time, a point of time, a time zone, weather information such as weather, and a car type in which the mobile object 1 is an automobile. For example, the predetermined time “t” is set short with respect to a date and time, a point of time, a time zone, a copy, and a car type in which a frequency of occurrence of an accident is statistically higher than a reference value, as compared with a date and time, etc., when the frequency is lower than the reference value, for example.

As illustrated in FIG. 5, the mobile object 1 is located within the motion estimation circle 4-2 after a predetermined time “2t” has elapsed. In this case, since an actual location of the mobile object 1 after a predetermined time has elapsed falls within a motion estimation circle, the mobile object 1 does not notify the management device 2 of location-relation information of the mobile object 1. In this case, similarly to the side of the mobile object 1, on the side of the management device 2, a motion estimation circle of the mobile object 1 after the predetermined time has elapsed is estimated. Therefore, the management device 2 manages an estimated area on the motion estimation circle as a location of the mobile object 1. Note that the management device 2 may manage a location where the mobile object 1 may be located with a high possibility within an estimated area on a motion estimation circle as a location of the mobile object 1. For example, the management device 2 may calculate a location where the mobile object 1 may be located with a highest possibility within a motion estimation circle, and manage the calculated location as a location of the mobile object 1.

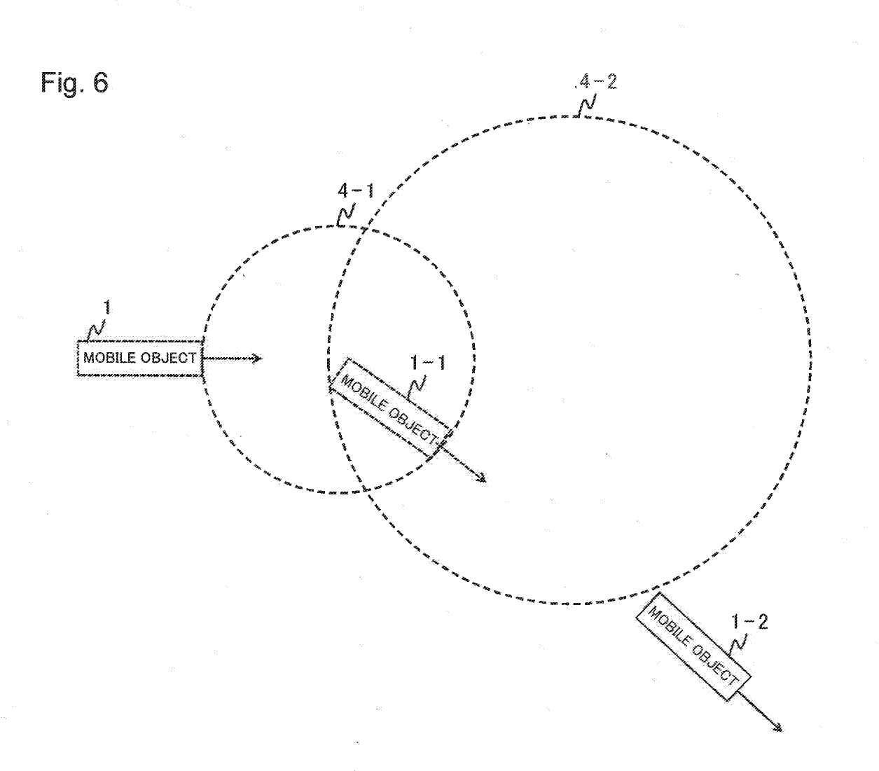

FIG. 6 is a diagram illustrating another relationship between a location of the mobile object 1 and a motion estimation circle after a predetermined time “2t” has elapsed.

As illustrated in FIG. 6, the mobile object 1 is located outside the motion estimation circle 4-2 after a predetermined time “2t” has elapsed. Specifically, this corresponds to a case where an error, between an actual location of the mobile object 1 after a predetermined time “2t” has elapsed and an estimated location, exceeds a predetermined threshold value. In this case, the mobile object 1 notifies the management device 2 of location-relation information of the mobile object 1 in response to an actual location of the mobile object 1 after a predetermined time has elapsed falling outside a motion estimation circle. When receiving location-relation information from the mobile object 1, the management device 2 calculates a location of the mobile object 1, based on the received location-relation information, and manages the calculated location of the mobile object 1 as a location of the mobile object 1.

The control unit 11 transmits location-relation information of the mobile object 1 to the management device 2 via the communication unit 10. The control unit 11 transmits, to the management device 2, location information on an own device measured by a GPS (e.g. a latitude and a longitude), for example. The control unit 11 notifies measured location-related information of an own device (e.g. a velocity and an acceleration of the own device), for example. The control unit 11 may notify the management device 2 of angular moment with respect to respective axes (X-axis, Y-axis, Z-axis), a “speed” being a scalar quantity, and the like as location-related information, in addition to a velocity and an acceleration of the mobile object 1, for example. The control unit 11 may notify the management device 2 of a motion model itself for use in calculating a location of the mobile object 1 as location-related information, for example. The control unit 11 may notify the management device 2 of a parameter of a motion model for use in calculating a location of the mobile object 1 as location-related information, for example. The control unit 11 may notify the management device 2 of a location of the mobile object 1 on a predetermined map as location-related information, for example.

When the mobile object 1 is an automobile, the control unit 11 may notify the management device 2 of information on a brake pedal, an acceleration pedal, and the like of the automobile as location-related information, for example.

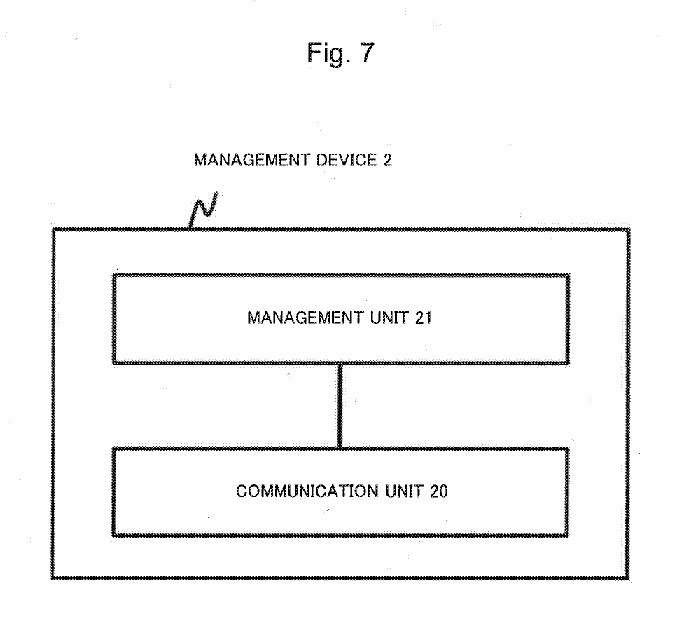

FIG. 7 is a diagram illustrating a configuration example of the management device 2 according to the first example embodiment. As illustrated in FIG. 7, the management device 2 includes a communication unit 20 and a management unit 21.

The communication unit 20 includes a function of transmitting and receiving a predetermined signal, data, and the like. The communication unit 20 is an interface for communication, for example. The management unit 21 manages location information on the mobile object 1. Location information to be managed by the management unit 21 is a latitude, a longitude, and an altitude of the mobile object 1, for example. Further, location information to be managed by the management unit 21 may be a location of the mobile object 1 on a predetermined map. Note that the management unit 21 may manage location-related information of the mobile object 1 and calculate location information on the mobile object 1 as necessary, in place of managing location information on the mobile object 1. It is needless to say that the management unit 21 may manage both of location information and location-related information of the mobile object 1.

The management unit 21 estimates a location of the mobile object 1 after a predetermined time has elapsed by using a communication model. A communication model for use in estimating a location of the mobile object 1 by the management unit 21 is associated with a communication model to be used by the mobile object 1, and the communication models may be the same, for example. Note that since the management unit 21 uses a communication model associated with a communication model to be used by the mobile object 1, an estimated location to be estimated by the control unit 11 of the mobile object 1, and an estimated location to be estimated by the management unit 21 become substantially same (or same) results.

Note that a predetermined time “t” and a size of a motion estimation circle for use in estimating a location of the mobile object 1 by the management unit 21 are associated with a predetermined time “t” and a size of a motion estimation circle for use in estimating a location of the mobile object 1 by the control unit 11 of the mobile object 1, and have a substantially same value (or same value) and a substantially same size (or same size), for example. In other words, a value of a predetermined time “t” and a size of a motion estimation area to be used by the control unit 11 are set to correspond to or be equal to a value of a predetermined time “t” and a size of a motion estimation area to be used by the management unit 21 so that estimation on a location by the control unit 11 of the mobile object 1 and estimation on a location by the management unit 21 of the management device 2 become substantially same results.

Note that since processing of estimating a location of the mobile object 1 by the management unit 21 is similar to processing of estimating a location of the mobile object 1 by the control unit 11 of the mobile object 1, detailed description is omitted.

When receiving location-relation information of the mobile object 1 from the mobile object 1, the management unit 21 manages location information on the mobile object 1, based on the received location-relation information. When receiving location information on the mobile object 1 from the mobile object 1, the management unit 21 manages the location information. When receiving location-related information of the mobile object 1 from the mobile object 1, the management unit 21 calculates location information on the mobile object 1 from the location-related information, and manages the calculated location information. Note that the management unit 21 may manage location-related information of the mobile object 1, in place of managing location information on the mobile object 1, and calculate location information on the mobile object 1 as necessary. When receiving a motion model from the mobile object 1, the management unit 21 may calculate a location of the mobile object 1 by using the motion model, and manage the calculated location of the mobile object 1.

After receiving location-relation information of the mobile object 1 from the mobile object 1, the management unit 21 manages an estimated location of the mobile object 1 estimated by using a predetermined communication model as a location of the mobile object 1 during a period until newly receiving location-relation information of the mobile object 1 from the mobile object 1.

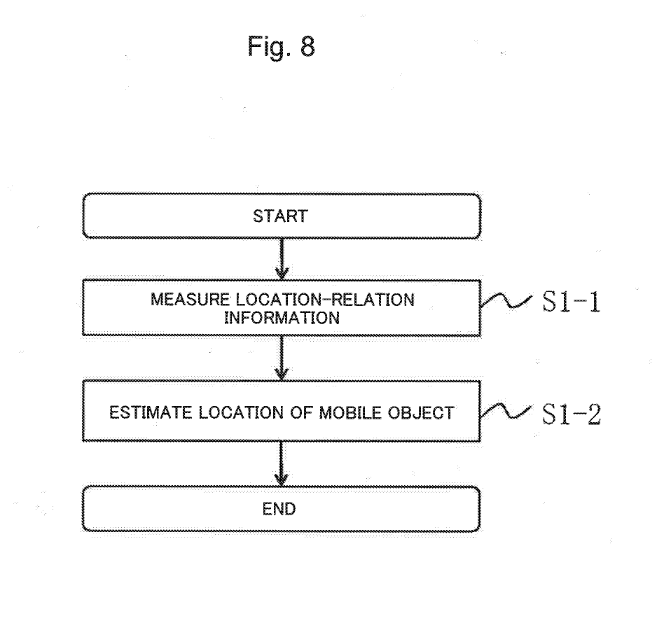

FIG. 8 is a flowchart illustrating an operation example of the mobile object 1 according to the first example embodiment. Note that FIG. 8 is an operation example when the control unit 11 of the mobile object 1 estimates a location of the mobile object 1.

The control unit 11 of the mobile object 1 measures a location of the mobile object 1 (S1-1). The control unit 11 measures a location of the mobile object 1 by a GPS, for example.

The control unit 11 estimates a location of the mobile object 1 after a predetermined time has elapsed by using a motion model, based on location-relation information of the mobile object 1 (S1-2). The control unit 11 uses a Kalman filter for estimating a location of the mobile object 1, for example. When a Kalman filter is used, the control unit 11 calculates an estimated location of the mobile object 1 after a predetermined time has elapsed, as a motion estimation circle.

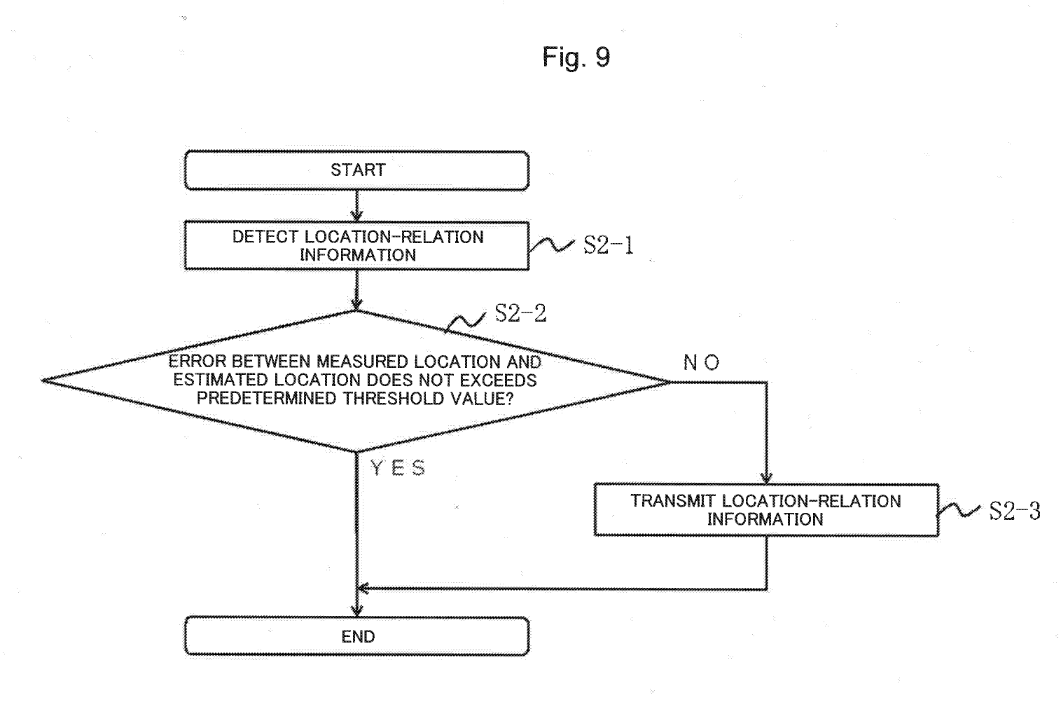

FIG. 9 is a flowchart illustrating another operation example of the mobile object 1 according to the first example embodiment. Note that FIG. 9 is an operation example of the mobile object 1 after a predetermined time has elapsed from the time when the control unit 11 of the mobile object 1 estimates a location of the mobile object 1.

The control unit 11 of the mobile object 1 measures a location of the mobile object 1 (S2-1). The control unit 11 measures a location of the mobile object 1 by a GPS, for example.

The control unit 11 determines whether or not an error between a measured location and an estimated location (estimation location) does not exceeds a predetermined threshold value (S2-2). The control unit 11 determines whether or not a measured location is included in a motion estimation circle estimated by using a Kalman filter, for example. Note that the control unit 11 may determine whether or not an error between a measured location and an estimated location exceeds a predetermined threshold value. Further, the control unit 11 may determine whether or not a measured location falls outside a motion estimation circle estimated by using a Kalman filter, for example.

When it is determined that the error does not exceeds a predetermined threshold value (“YES” in S2-2), the control unit 11 finishes the processing without notifying the management device 2 of location-relation information of the mobile object 1. On the other hand, when it is determined that the error exceeds the predetermined threshold value (“NO” in S2-2), the control unit 11 notifies the management device 2 of location-relation information of the mobile object 1 via the communication unit 10 (S2-3). When a measured location falls outside a motion estimation circle estimated by using a Kalman filter, for example, the control unit 11 notifies the management device 2 of location-relation information of the mobile object 1.

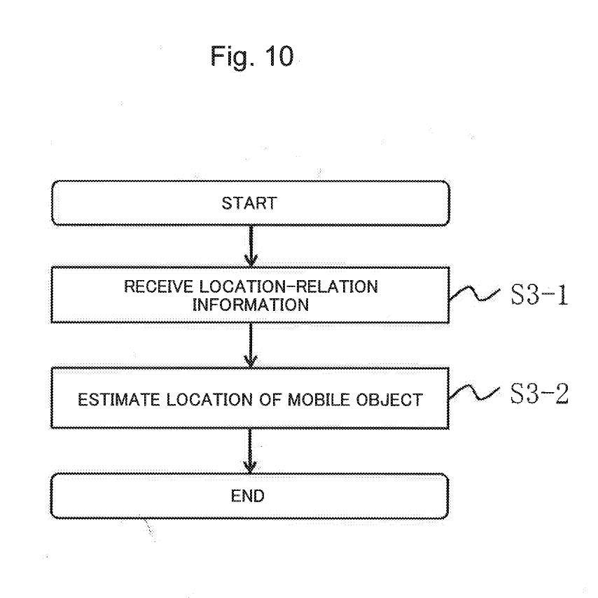

As described above, when an error between a measured location and an estimated location (estimation location) does not exceeds a predetermined threshold value, the mobile object 1 does not notify the management device 2 of location-relation information of the mobile object 1. Consequently, it is possible to prevent an increase in communication traffic, since it is possible to reduce location-relation information of the mobile object 1, which is transmitted from the mobile object 1 to the management device 2. FIG. 10 is a flowchart illustrating an operation example of the management device 2 according to the first example embodiment. Note that FIG. 10 is an operation example when the management device 2 receives location-relation information from the mobile object 1.

The management unit 21 of the management device 2 receives location-relation information of the mobile object 1 via the communication unit 20 (S3-1).

The management unit 21 estimates a location of the mobile object 1 after a predetermined time has elapsed by using a motion model, based on the received location-relation information of the mobile object 1 (S3-2). The management unit 21 calculates a motion estimation circle of the mobile object 1 after a predetermined time has elapsed by using a Kalman filter, for example.

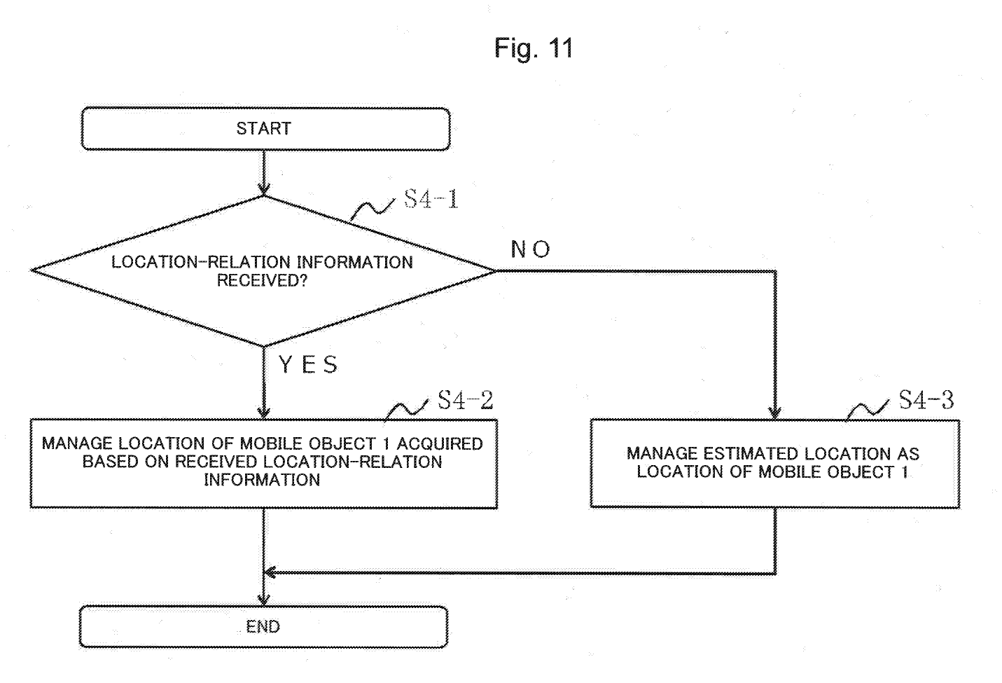

FIG. 11 is a flowchart illustrating another operation example of the management device 2 according to the first example embodiment. Note that FIG. 11 is an operation example of the management device 2 after a predetermined time has elapsed from the time when the management device 2 receives location-relation information from the mobile object 1.

The management unit 21 of the management device 2 determines whether or not location-relation information is newly received from the mobile object 1 after a predetermined time has elapses from the time when the management device 2 receives location-relation information from the mobile object 1, for example (S4-1).

When location-relation information is newly received from the mobile object 1 (“YES” in S4-1), the management unit 21 manages a location of the mobile object 1 acquired based on the newly received location-relation information (S4-2).

On the other hand, when location-relation information is not received from the mobile object 1 (“NO” in S4-1), the management unit 21 manages the estimated location of the mobile object 1 estimated in S3-2 in FIG. 10 as a location of the mobile object 1 (S4-2). As described above, when an error, between a location and an estimated location of the mobile object 1 after a predetermined time has elapsed, is small compared with an estimated location, the management device 2 manages the estimated location as a location of the mobile object 1. Since an error between an actual location and an estimated location is small, the management device 2 is able to manage the estimated location as a location of the mobile object 1. Further, since the management device 2 manages an estimated location as a location of the mobile object 1, the management device 2 does not have to newly receive notification on location information on the mobile object 1 from the mobile object 1. Therefore, the mobile object 1 does not have to notify the management device 2 of location information on the mobile object 1. This enables to suppress an increase in communication traffic.

### Second Example Embodiment

A second example embodiment of the present invention is an example embodiment in a case where a management device 2 notifies a mobile object 1 of a location of another mobile object 1. Note that a technique of the second example embodiment is applicable to any of the first example embodiment and an example embodiment to be described later.

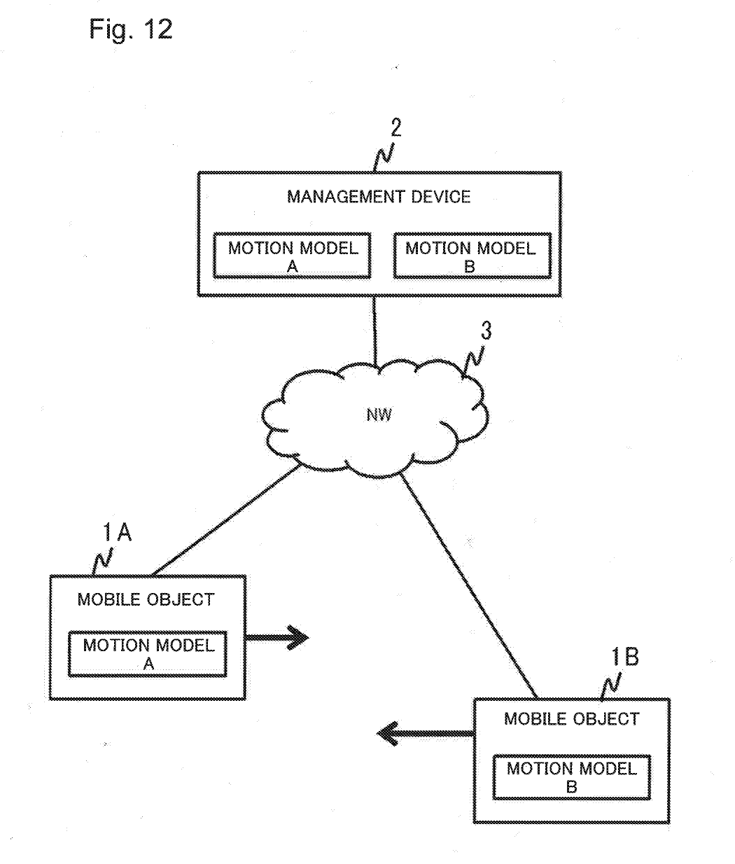

FIG. 12 is a configuration example of a management system according to the second example embodiment. As illustrated in FIG. 12, the second management system includes a plurality of mobile objects 1, the management device 2, and a NW 3. The management system according to the second example embodiment is such that the respective plurality of mobile objects 1 transmit and receive mutual location-relation information via the NW 3 and the management device 2.

The management device 2 holds a motion model associated with each of the plurality of mobile objects 1. As illustrated in FIG. 12, the management device 2 holds a motion model A with respect to a mobile object 1A, and a motion model B with respect to a mobile object 1B. Note that motion models to be held by the respective plurality of mobile objects 1 may be same motion models. In other words, the motion model A to be held by the mobile object 1A, and the motion model B to be held by the mobile object 1B may be same motion models. In this case, when the management device 2 holds same motion models, it is possible to estimate both locations of the mobile object 1A and the mobile object 1B by the same motion models.

The management device 2 manages respective pieces of location information on the plurality of mobile objects 1 (the mobile object 1A and the mobile object 1B). The management device 2 includes a function of notifying the respective plurality of mobile objects 1 on which location information is managed of location information on another mobile object 1, for example.

When receiving location-relation information of another mobile object 1 from the management device 2, the respective plurality of mobile objects 1 notify a user of the mobile object 1 of the location of the another mobile object 1 by displaying the location of the another mobile object 1, for example.

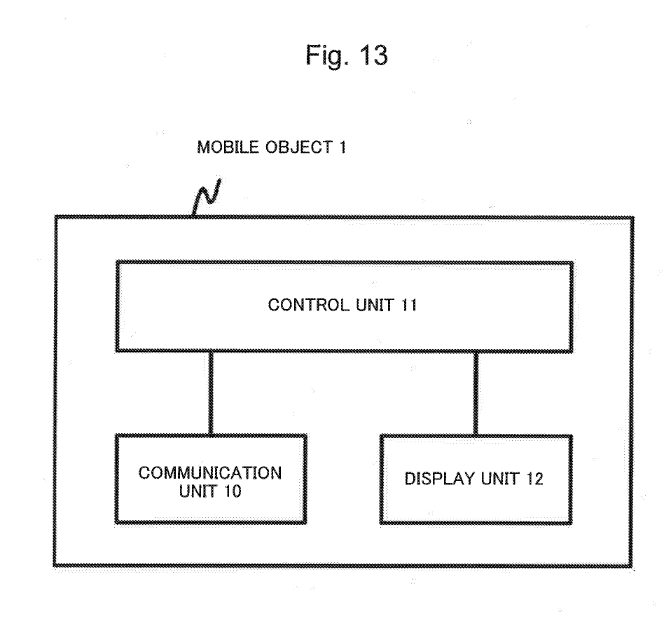

FIG. 13 is a diagram illustrating a configuration example of the mobile object 1 according to the second example embodiment. As illustrated in FIG. 13, the mobile object 1 includes a communication unit 10, a control unit 11, and a display unit 12.

Since the communication unit 10 and the control unit 11 have similar configurations to the communication unit 10 and the control unit 11 of the mobile object 1 according to the first example embodiment illustrated in FIG. 2, detailed description is omitted.

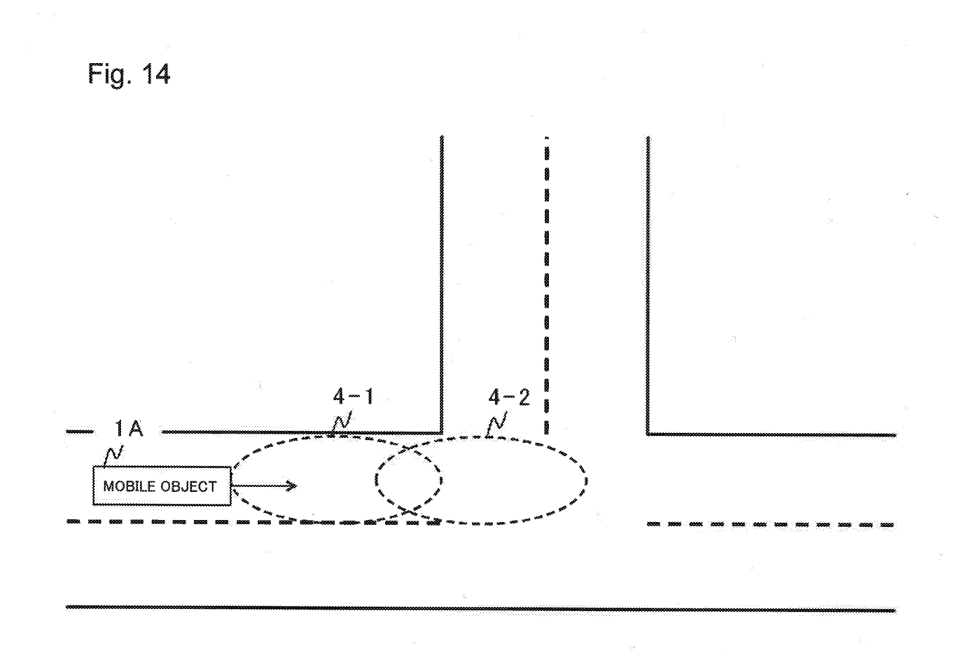

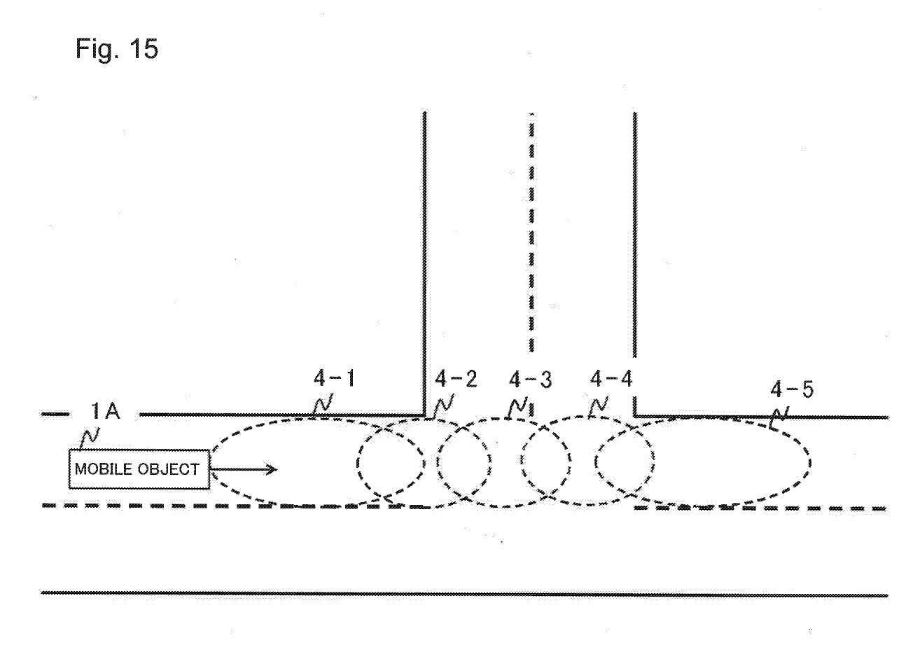

Herein, a location (motion estimation circle) of the mobile object 1 to be estimated by the control unit 11 when the mobile object 1 is an automobile is described by using FIG. 14 and FIG. 15. Note that since the control unit 11 and a management unit 21 of the management device 2 estimate a location of the mobile object 1 by using associated motion models, estimation examples of FIG. 14 and FIG. 15 also illustrate an estimated location (estimation area) of the mobile object 1 to be estimated by the management unit 21.

FIG. 14 is an example of a motion estimation area of the mobile object 1 being an automobile, which is estimated by the control unit 11 and the management unit 21. As illustrated in FIG. 14, the control unit 11 of the mobile object 1 being an automobile estimates a location of the automobile after a predetermined time has elapsed on a road where the automobile travels. As illustrated in FIG. 14, the control unit 11 and the management unit 21 calculate a motion estimation area after a predetermined time has elapsed along a road where the mobile object 1 being an automobile travels. The control unit 11 calculates a motion estimation area 4-1 after a predetermined time “t” has elapsed, and a motion estimation area 4-2 after a predetermined time “2t” has elapsed, for example.

As illustrated in FIG. 14, when the mobile object 1 is an automobile, it is possible to set a motion estimation area of the mobile object 1, as an area on a road where the automobile is allowed to travel. Specifically, the motion estimation area 4-1 is allowed to have a long length in a traveling direction (X direction) of the mobile object 1, and have a fixed length in a road width direction i.e. a direction (Y direction) orthogonal to the traveling direction (specifically, a fixed length in Y direction). Since an automobile normally has a narrow moving range in a road width direction, it is possible to set a motion estimation area as a motion estimation area associated with actual movement of the automobile by narrowing the motion estimation area in the road width direction.

FIG. 15 is another example of a motion estimation area of the mobile object 1 being an automobile, which is estimated by the control unit 11 and the management unit 21. As illustrated in FIG. 15, when the mobile object 1 being an automobile is located near an intersection, the control unit 11 and the management unit 21 estimate a location of the mobile object 1 in detail by setting an interval of predetermined time “t” short. It is highly likely that the mobile object 1 being an automobile comes close to a pedestrian or another automobile near an intersection, for example. In view of the above, by increasing number of calculation times of a motion estimation area near an intersection, it becomes possible to secure accuracy on a location of the mobile object 1 to be managed by the management device 2 by comparing the motion estimation area and an actual location of an automobile at a short interval.

Further, as illustrated in FIG. 15, when the mobile object 1 being an automobile is located near an intersection, the control unit 11 and the management unit 21 may reduce the size itself of a motion estimation area to be estimated. Since the size of a motion estimation area is small, an estimated location of the mobile object 1 comes close to an actual location of the mobile object 1. This enables to secure accuracy on a location of the mobile object 1 to be managed by the management device 2. Further, since an error, between an actual location of the mobile object 1 and an estimated location, is likely to occur, a frequency by which the mobile object 1 notifies the management device 2 of location-relation information of the mobile object 1 increases. This enables to secure accuracy on a location of the mobile object 1 to be managed by the management device 2.

Note that a motion estimation area of the mobile object 1 to be estimated by the control unit 11 and the management unit 21 may be set, based on predetermined map information. The control unit 11 and the management unit 21 set a motion estimation area based on a condition of a place where the mobile object 1 is located by using predetermined map information. The control unit 11 and the management unit 21 set a motion estimation area depending on a legal speed limit of a road where the mobile object 1 is located by using predetermined map information, for example. The control unit 11 and the management unit 21 set a motion estimation area of the mobile object 1 wider, as a legal speed limit increases, for example. The control unit 11 and the management unit 21 set a motion estimation area of the mobile object 1 located near an intersection by using predetermined map information, for example. The control unit 11 and the management unit 21 set a motion estimation area of the mobile object 1 located near an intersection narrow, for example. The control unit 11 and the management unit 21 set a motion estimation area of the mobile object 1 located on a mountain road by using predetermined map information, for example. The control unit 11 and the management unit 21 set a motion estimation area of the mobile object 1 traveling on a mountain road narrow, for example. The control unit 11 and the management unit 21 set a motion estimation area of the mobile object 1 by using predetermined map information and traffic congestion information, for example. The control unit 11 and the management unit 21 set a motion estimation area of the mobile object 1 traveling on a congested road narrow, for example.

The management unit 21 of the management device 2 identifies a location of the mobile object 1 on a predetermined map, for example, and notifies the mobile object 1 of the predetermined map information by notifying the mobile object 1 of map information at the identified location. Note that the control unit 11 of the mobile object 1 may identify a location of the mobile object 1 on a predetermined map, and notify the management device 2 of map information at the identified location.

The display unit 12 has a function of, when receiving location-relation information of another mobile object 1 from the management device 2, displaying the location information on the another mobile object 1. The display unit 12 displays location information on an own device and received location information on another mobile object 1 on a map, for example.

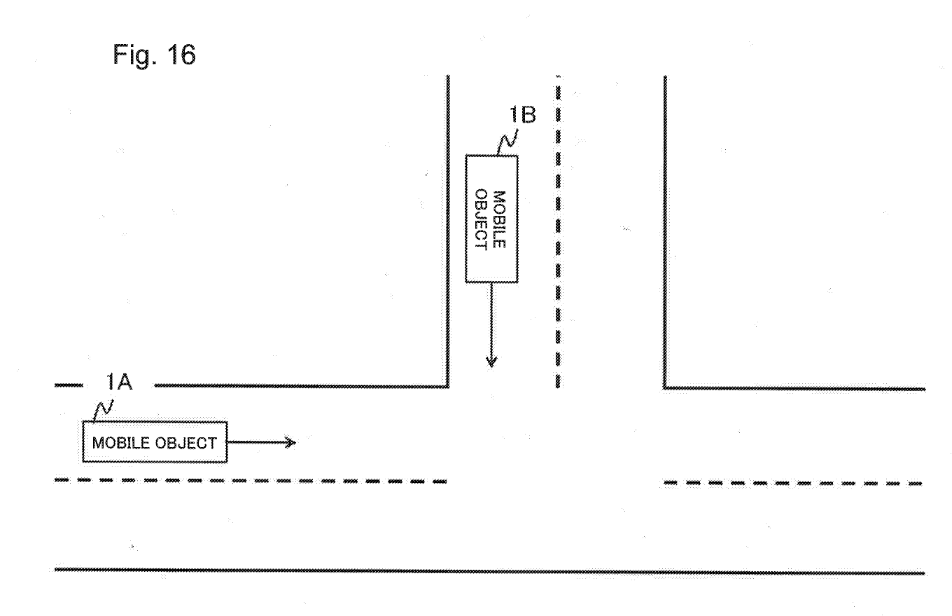

FIG. 16 is a display example when the display unit 12 displays locations of an own device (mobile object 1A) and another mobile object 1B on a map. As illustrated in FIG. 16, since the display unit 12 displays locations of the mobile object 1A and the mobile object 1B on a map, a user of the mobile object 1A is able to know that the mobile object 1B is approaching.

Herein, a configuration example of the management device 2 is similar to a configuration example of the management device 2 according to the first example embodiment illustrated in FIG. 7.

The management unit 21 of the management device 2 manages location-relation information of a plurality of mobile objects 1, and determines a mobile object 1 whose location-relation information is shared, based on the location-relation information to be managed. The management unit 21 determines the mobile object 1A and the mobile object 1B, as mobile objects 1 whose location information is shared, based on location information on the mobile object 1A and the mobile object 1B to be managed, for example. The management unit 21 determines mobile objects 1 at a short distance among a plurality of mobile objects 1, as mobile objects 1 whose mutual location-relation information is shared, for example. When the mobile object 1 is an automobile, for example, the management unit 21 determines a plurality of mobile objects 1 located near an intersection on a map, as mobile objects 1 whose location-relation information is shared. Note that a method for determining mobile objects 1 whose location-relation information is shared by the management unit 21 is not limited to a method for determining, based on a distance between mobile objects 1, but may be any method such as determination based on an attribute of the mobile object 1 and the like, for example.

The management unit 21 notifies respective mobile objects 1 between which location information is determined to be shared, of location-relation information of another mobile object 1.

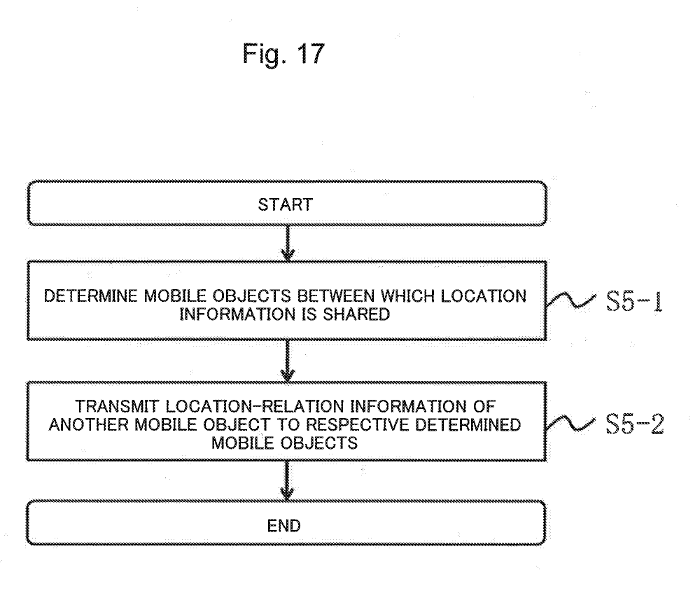

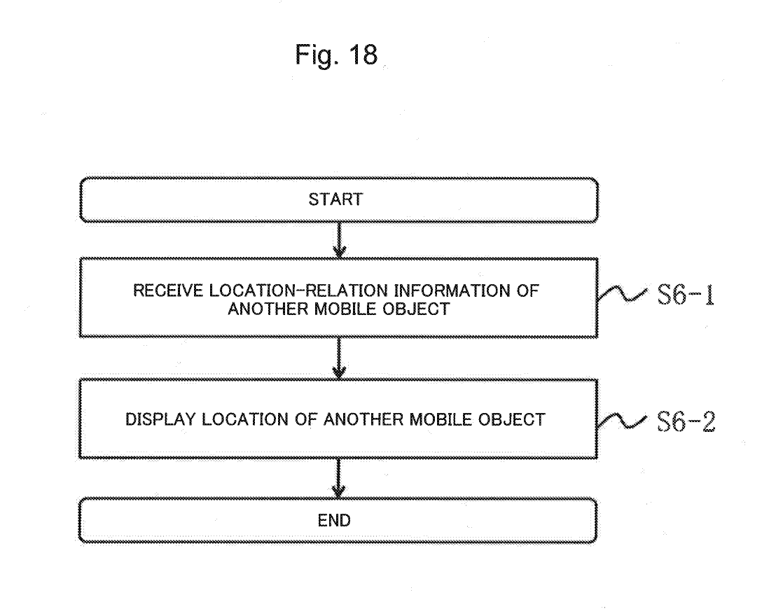

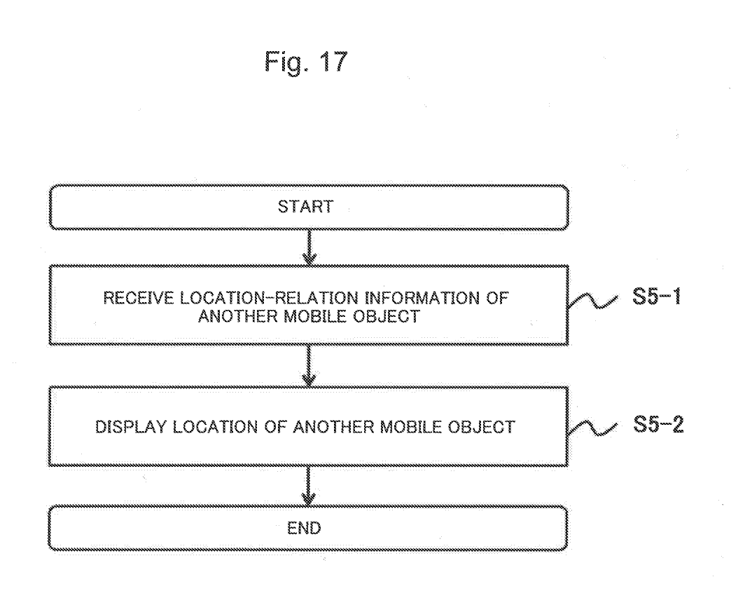

FIG. 17 is a diagram illustrating an operation example of the mobile object 1 according to the second example embodiment. Note that since an operation example when the mobile object 1 estimates a location, and an operation example when the mobile object 1 notifies the management device 2 of location-relation information are similar to the operation examples illustrated in FIG. 8 and FIG. 9, detailed description is omitted.

The control unit 11 of the mobile object 1 receives, from the management device 2, location-relation information of another mobile object 1 via the communication unit 10 (S5-1).

The display unit 12 displays the received location of the another mobile object 1 on a map in response to designation from the control unit 11 (S5-2).

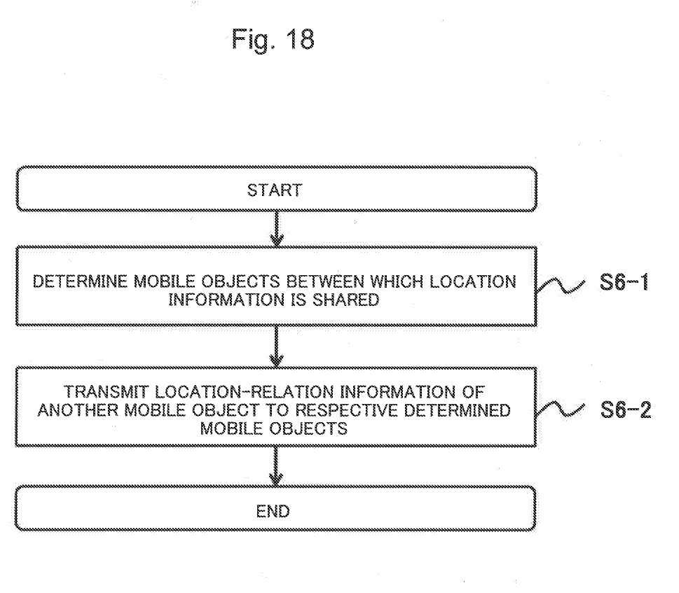

FIG. 18 is a diagram illustrating an operation example of the management device 2 according to the second example embodiment. Note that since an operation example when the management device 2 manages a location, and an operation example when the management device 2 estimates a location of the mobile object are similar to the operation examples illustrated in FIG. 10 and FIG. 11, detailed description is omitted.

The management unit 21 of the management device 2 determines a plurality of mobile objects 1 between which location information is shared, based on location-relation information of the mobile object 1 to be managed (S6-1). The management unit 21 determines mobile objects 1 at a short distance among a plurality of mobile objects 1, as mobile objects 1 which share mutual location-relation information.

The management unit 21 transmits location-relation information of another mobile object 1 to the respective determined mobile objects 1 via a communication unit 20 (S6-2).

As described above, since the management device 2 according to the second example embodiment notifies the mobile object 1 of a location of another mobile object 1, a user of the mobile object 1 is able to know the another mobile object 1 located near an own device.

Further, in the present invention, the mobile object 1, a computer of the management device 2, a central processing unit (CPU), a micro-processing unit (MPU), or the like may execute a software (program) for implementing functions of the respective example embodiments. The mobile object 1 and the management device 2 may acquire a software (program) for implementing functions of the above-described respective example embodiments via various storage media such as a compact disc recordable (CD-R) or a network, for example. A program to be acquired by the mobile object 1 and the management device 2, and a storage medium storing the program constitute the present invention. Note that the software (program) may be stored in advance in a predetermined storage unit included in the mobile object 1 and the management device 2. The terminal 1 or a computer of respective network nodes, a CPU, an MPU, or the like may read and execute program codes of an acquired software (program). Therefore, the mobile object 1 and the management device 2 execute same processing as the processing of the mobile object 1 and the management device 2 according to the respective example embodiments.

In the foregoing, example embodiments of the present invention are described. The present invention, however, is not limited to the respective example embodiments described above. The present invention is implementable, based on modifications/replacements/adjustments of the respective example embodiments. Further, the present invention is implementable by optionally combining the respective example embodiments. Specifically, the present invention includes various modifications and revisions capable of being implemented in accordance with all contents of disclosure and technical ideas of the present specification. Further, the present invention is also applicable to a technical field of a software-defined network (SDN).

This application is based upon and claims the benefit of priority from Japanese patent application No. 2015-255557, filed on Dec. 28, 2015, the disclosure of which is incorporated herein in its entirety by reference.

### REFERENCE SIGNS LIST

1 Mobile object
2 Management device
3 NW
4 Motion estimation area
10 Communication unit
11 Control unit
12 Display unit
20 Communication unit
21 Management unit

What is claimed is:

1. A management system comprising:
a mobile object for estimating a location of an own device after a predetermined time elapses by using a predetermined motion model; and
a management device for estimating a location of the mobile object after the predetermined time elapses by using the predetermined motion model, wherein
the mobile object transmits, to the management device, location-relation information of the own device when an error, between the location of the own device measured after the predetermined time elapses and the estimated location of the own device, exceeding a predetermined threshold value.

2. (canceled)

3. (canceled)

4. (canceled)

5. (canceled)

6. (canceled)

7. (canceled)

8. A mobile object comprising:
a transmission unit for transmitting location-relation information of an own device to a management device; and
an estimation unit for estimating a location of the own device after a predetermined time elapses, wherein
the estimation unit transmits the location-relation information of the own device via the transmission unit when an error, between the location of the own device measured after the predetermined time elapses and the estimated location of the own device, exceeding a predetermined threshold value.

9. The mobile object according to claim 8, wherein
the estimation unit transmits, to the management device, the location-relation information of the mobile object after the predetermined time elapses when an error, between the location of the own device measured after the predetermined time elapses and the estimated location of the own device, exceeding the predetermined threshold value.

10. The mobile object according to claim 8, wherein
the estimation unit calculates a motion estimation area of the mobile object after the predetermined time elapses, and transmits the location-relation information of the own device via the transmission unit when the location of the own device measured after the predetermined time elapses falls outside the motion estimation area.

11. The mobile object according to claim 10, wherein
the estimation unit sets a size of the motion estimation area depending on an attribute of the mobile object.

12. The mobile object according to claim 8, wherein
the estimation unit calculates a motion estimation circle of the mobile object after the predetermined time elapses by using a Kalman filter, and transmits the location-relation information of the own device via the transmission unit when the location of the own device measured after the predetermined time elapses falls outside the motion estimation circle.

13. The mobile object according to claim 8, wherein
the estimation unit sets the predetermined time depending on an attribute of the mobile object.

14. A management device for managing a location of a mobile object, the management device comprising:
a reception unit for receiving location-relation information of the mobile object from the mobile object; and
an estimation unit for estimating a location of the mobile object after a predetermined time elapses, wherein
the estimation unit manages the estimated location as the location of the mobile object during a period until newly receiving the location-relation information of the mobile object after receiving the location-relation information of the mobile object.

15. The management device according to claim 14, wherein
the estimation unit manages the estimated location as the location of the mobile object during a period until newly receiving the location-relation information of the mobile object after receiving the location-relation information of the mobile object, from the mobile object.

16. The management device according to claim 14, wherein
the estimation unit calculates a motion estimation area of the mobile object after the predetermined time elapses.

17. The management device according to claim 14, wherein
the estimation unit calculates a motion estimation circle of the mobile object after the predetermined time elapses by using a Kalman filter.

18. The management device according to claim 14, wherein
the estimation unit sets the predetermined time depending on an attribute of the mobile object.

19. A location notification method comprising:
transmitting, to a management device, location-relation information of an own device being a mobile object;
estimating a location of the own device after a predetermined time elapses; and
transmitting, to the management device, the location-relation information of the own device when an error, between the location of the own device measured after the predetermined time elapses and the estimated location of the own device, exceeding a predetermined threshold value.

20. (canceled)

21. (canceled)

22. (canceled)

23. (canceled)

24. (canceled)

25. A management method comprising:
receiving location-relation information of a mobile object from the mobile object;
estimating a location of the mobile object after a predetermined time elapses; and
managing the estimated location as the location of the mobile object during a period until newly receiving the location-relation information of the mobile object after receiving the location-relation information of the mobile object.

26. (canceled)

27. (canceled)

28. (canceled)

29. (canceled)

30. A storage medium storing a program causing a computer to execute:
transmitting location-relation information of an own device to a management device;
estimating a location of the own device after a predetermined time elapses; and
transmitting, to the management device, the location-relation information of the own device when the error, between the location of the own device measured after the predetermined time elapses and the estimated location of the own device, exceeding a predetermined threshold value.

31. A storage medium storing a program causing a computer to execute:
receiving location-relation information of a mobile object from the mobile object;
estimating a location of the mobile object after a predetermined time elapses; and
managing the estimated location as the location of the mobile object during a period until newly receiving location-relation information of the mobile object after receiving information of the mobile object.

32. The management device according to claim 16, wherein
the estimation unit sets a size of the motion estimation area depending on an attribute of the mobile object.
